(19) United States
(12) Patent Application Publication
(10) Pub. No.: US 2018/0094846 A1
(43) Pub. Date: Apr. 5, 2018

(54) ZONE ISOLATION CONTROL SYSTEM FOR TRANSPORT REFRIGERATION UNIT

(71) Applicant: RONALD KOELSCH, Roscommon, MI (US)

(72) Inventor: RONALD KOELSCH, Roscommon, MI (US)

(21) Appl. No.: 15/283,710

(22) Filed: Oct. 3, 2016

(51) Int. Cl. F25D 11/00; B60P 3/20; F25B 21/02; F25B 40/02; F25D 11/02; F25D 17/06; F25B 27/00; F25D 29/00; F25D 23/12; H02S 99/00; H02S 10/40

(52) U.S. Cl. CPC F25D 11/003; F25D 2700/02; F25B 21/02; F25B 40/02; F25D 11/022; F25D 17/06; F25B 27/005; F25D 29/003; F25D 11/006; F25D 23/12; H02S 99/00; H02S 10/40; F25B 2500/28; F25D 2400/02; B60P 3/20

(57) ABSTRACT

Multi-zone transport refrigeration units (TRUs). A combination of temperature controlled flow of cold air and time controlled refrigerant distribution is used to improve cooling performance and reduce power consumption. This dual-control zone isolation system makes it possible to use solar panels to power the TRU.

This application is a utility application claiming priority from U.S. Provisional patent application Ser. No. 62/245,366, filed Oct. 23, 2015.

### BACKGROUND OF THE INVENTION

The instant invention relates to the efficiency of multi-zone transport refrigeration units (TRUs).

Present art TRUs move refrigerant from the freezer area to the less efficient refrigerator area to provide refrigerator cooling using remote evaporators. Cooling performance in the freezer suffers from this removal of refrigerant from the freezer area, to the extent that the air temperature in the freezer can go above freezing temperature when the refrigerator is in high-demand cooling.

Prior art battery operated transfer refrigeration units without zone control are known from U.S. Pat. No. 8,935,933 and prior art backup power generators for battery powered transport refrigeration units are described in U.S. Pat. No. 9,415,660.

### THE INVENTION

What is disclosed and claimed herein is a high efficiency battery powered TRU with zone isolation comprising a refrigeration system wherein timer controls are used to limit refrigerant flow from a freezer zone to remote evaporators and said remote evaporators are located in refrigeration zones other than a host freezer zone.

There is also a refrigeration air handling system wherein air is extracted directly from a post evaporator cold-air chamber of the host freezer zone, and extracted air is distributed to each of the refrigeration zones to control a single zone temperature, or multiple temperatures in multiple zones, by airflow control, using a combination of fans, ducts, gates and air temperature controllers.

In addition, there is a high efficiency battery powered TRU with zone isolation as set forth Supra, wherein there is a battery that powers said TRU refrigeration system that consumes less than 18 Kwh of electrical energy.

Each zone is predetermined to be a unit selected from a freezer zone, a refrigerator zone, or an ambient temperature zone depending on the desired make-up of the system.

The control system comprises for each zone at least, an evaporation unit containing a rod heater, a cold plate, a heater, an input fan for each zone, an output fan for each zone, and, an output fan for said evaporator. Each zone is equipped with a timer.

In addition, there is an embodiment wherein the system is combined and connected to at least one solar panel to provide power to the zone isolation control system and the entire refrigeration system.

It has been discovered that this inefficient use of refrigerant by the refrigerator area is minimized or eliminated by zone isolation and freezer temperatures are easily maintained. The zone isolation system of this invention prioritizes the freezer and moves little or no refrigerant to the refrigerator.

Cold air is taken from the more efficient freezer area (sometimes called the “host zone”) and moved to the refrigerator area. The airflow is temperature controlled. The set-point temperature of the refrigerator is maintained while enhancing refrigerator performance. Unlike refrigeration systems that use remote evaporators, this invention does not degrade freezer performance because there is more than enough cooling capacity designed into the freezer, since it is not being starved for refrigerant, to quickly make up for the cold air that has been removed from the freezer.

An airflow system of ducting and pass-through openings is sequenced on a temperature control basis to bring cold air from the freezer to the refrigerator as needed to keep the proper temperature in the refrigerator. Refrigerant is never removed from the freezer zone, allowing it to always operate at peak performance. When the freezer is in very high demand cooling there may not be enough superheat to keep the refrigerant returning to the compressor from the evaporator in gas phase. Liquid refrigerant entering the compressor will cause it to knock. A knock sensor is employed to heat the refrigerant back to gas phase or shut the refrigeration unit off before the compressor is damaged. This enables the host zone to safely operate at high capacity thus providing sufficient cold air for the airflow system.

This airflow system eliminates the need for remote evaporators currently used in the prior art units, for example, in the non-freezer chambers. These chambers sometime require heated air when outside ambient temperatures are below freezing. Electric heater rods are used in this airflow system to quickly provide warm air, when required, to maintain above freezing refrigerator temperatures and to defrost the evaporator. TRUs designed with this airflow system operate more efficiently and consume less energy while maintaining better temperature control.

In that case, timer controls are used to limit refrigerant flow to the remote evaporators in the refrigerator zones and favor flow to the freezer zone. Diesel powered TRUs are typically designed with remote evaporators. When removing the diesel engine and converting the TRU to electric power, timer controls are used to limit refrigerant flow to the remote evaporators in the refrigerator zones and favor flow to the freezer zone. Uncontrolled-excessive flow of refrigerant to remote evaporators is eliminated. This prioritizes cooling in the freezer where high capacity cooling and efficient use of refrigerant is designed into the refrigeration system to keep product frozen. TRUs designed with remote evaporators benefit from combining this timer controlled freezer zone prioritization system with the temperature controlled cold airflow system.

A dual-control configuration comprised of time control of refrigerant movement and temperature control of cold air movement from the freezer “host” zone to the refrigerator results in improved temperature control in both the freezer and refrigerator. Overall efficiency is improved. This dual-control zone isolation system can also be used to improve the efficiency of single temperature TRUs by providing superior cold air distribution. This zone isolation control system solves another TRU cooling problem.

When the refrigerator door of a TRU is opened and the refrigerator chamber is exposed to warmer outside air, the refrigerator goes into high-demand cooling and draws too much cooling capacity from the freezer. The resulting low freezer performance puts frozen product at risk and does not meet the spirit of the Food Safety Modernization Act. The zone isolation system of the present invention eliminates this problem by stopping airflow and/or refrigerant flow to the opened refrigerator and outside air is not drawn into the refrigerator. A sensor detects the refrigerator door “open” condition and a signal is sent to the zone isolation controller to completely shut down the exposed refrigerator zone or in a circumstance where some refrigerator cooling is still desired, reduce its cooling duty cycle. The freezer continues normal operation while the refrigerator is shut down.

This decoupling of the freezer from the refrigerator using the zone isolation system means that the freezer keeps running efficiently independent of the refrigerator even though the refrigerator door is open. Energy consumption is reduced because the performance of each zone is isolated from the other zones.

The performance of any TRU is improved with the zone isolation system, but battery powered TRUs especially benefit from this lower power consumption. Their run time is determined by to the total energy stored in the battery versus the energy consumption of the refrigeration unit. Present state of the art battery powered TRUs use 18 Kwh of energy or more. The above-described high-efficient battery powered TRU using zone isolation has a lower duty cycle and consumes less than 18 Kwh of energy. This high efficiency battery powered TRU using less than 18 Kwh of energy can then be designed with new features that greatly benefit the environment.

Solar panels are placed on the roof of a semi-trailer. The area available is now sufficient to provide enough electric energy to match the lower energy consumption of the high-efficiency battery powered TRU. Run time is now not limited by battery capacity. There is enough power generated by the solar panel to run the refrigeration system and keep the battery fully charged. The power generated by the solar panel is sufficient to run the high-efficiency battery powered TRU using less than 18 Kwh of energy without using any other power generation source.

A backup power source can be added in the form of a wheel driven generator system (32). Adjusting the voltage regulator so the system is purely regenerative eliminates increased semi-tractor fuel consumption and emissions. An accelerometer controls the voltage regulator so power is only generated during deceleration. There is no additional drag on the tractor during acceleration and cruise. The system can be programed to generate continuous power during an emergency low-battery voltage condition whenever the speed of motion is above a set minimum speed.

Present state of the art battery powered TRUs typically use direct current motors that are of either brushed or brushless designs. With the high-efficiency battery powered TRU described herein it is feasible to use a dc to ac power inverter without exceeding its design limitations. This allows the use of a less expensive ac motor.

The zone isolation control system lends itself to a novel host evaporator design. Warmer return air from the refrigeration chambers is directed into one side of the evaporator where it is cooled by passing over the evaporator fins on this one side. Then it is redirected in the manner of a U shape to flow back through the other side of the evaporator and return into the cold air chamber. This second pass through the evaporator gives faster cooling response and improves the performance of the evaporator increasing the overall capacity of the refrigeration system.

Evaporator performance can foe supplemented by the use of cooling plates composed of eutectic solutions or phase change materials. Cooling capacity is stored in the cooling plates and extracted by airflow as needed to maintain proper refrigeration chamber temperatures or to cool battery assemblies. In some designs it is feasible to replace the evaporator with these cooling plates.

The battery cells are assembled into a box. The box is made of metal, usually stainless steel. The empty space in the assembled battery box is filled with expanded glass beads. If the battery assembly has a high temperature event, the expanded glass beads absorb released hot gases and act as a fire suppressant to prevent a fire from thermal runaway. The battery box can be made from expanded glass aggregate panels. These panels perform the same function as the expanded glass beads.

A thermoelectric cooling unit is installed after the condenser to act as a sub-cooler of the refrigerant. This gives additional condenser capacity when needed by simply switching electric power to the thermoelectric device. This device can also be used to provide cooling for temperature sensors. The sensor temperature is kept close to the cooling zone set point so its response time to big temperature changes from ambient to set point is improved.

When the solar powered TRUs are parked in the warehouse yard for loading or staging, they can be plugged into a common power network. The fleet of TRUs becomes a local solar power generation plant where individual TRUs that need battery charging get power from not only their own solar panel but also the solar panel from all other TRUs that are fully charged.

### BRIEF DESCRIPTION OF THE DRAWINGS

FIG. 1 is a full side view in perspective of a reefer showing predetermined zones and the use of a solar panel on the top of the semi-trailer. A wheel driven generator assembly and battery are shown.

FIG. 2 is a schematic showing timer controlled relay switches providing electric power on and off to each cooling zone individually.

FIG. 3 shows cold air being routed from the freezer to the refrigerator using a system of fans, ducting and controlled gates as well as an electric heating element in the evaporator area that is used to provide refrigerator heating in cold ambient conditions and a rod heater to defrost the evaporator.

FIG. 4 is art enlarged view of the refrigeration unit showing the knock sensor on the compressor and the return refrigerant line heater. The DC to AC inverter and AC motor are shown.

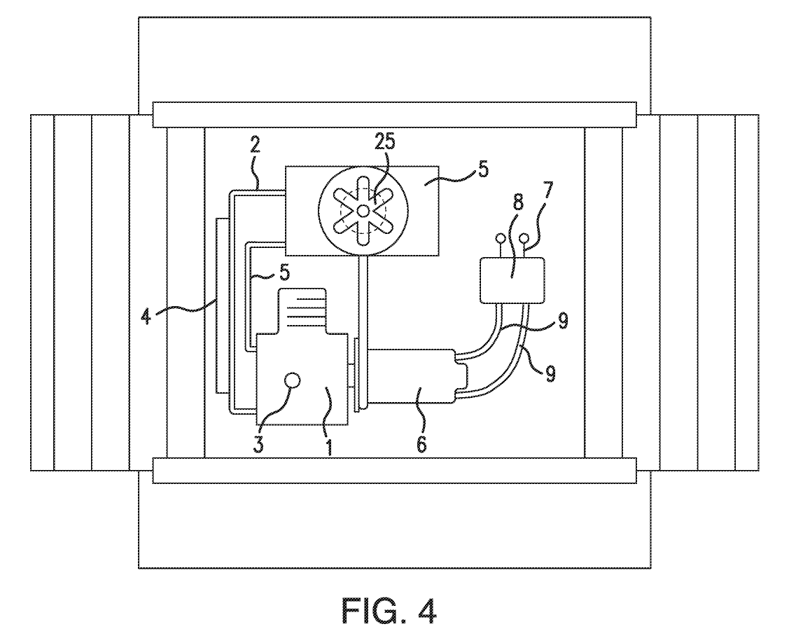

FIG. 5 is full rear view of the TRU showing the partially open rolling door and switch.

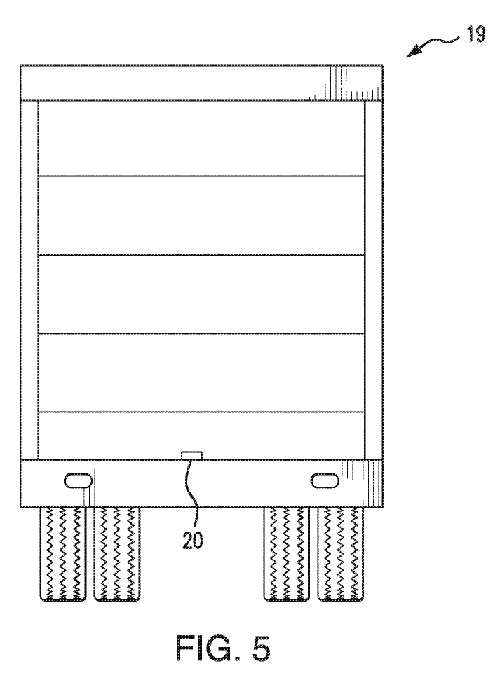

FIG. 6 is a view in perspective, from the top, of the U-shaped airflow through the double-pass evaporator.

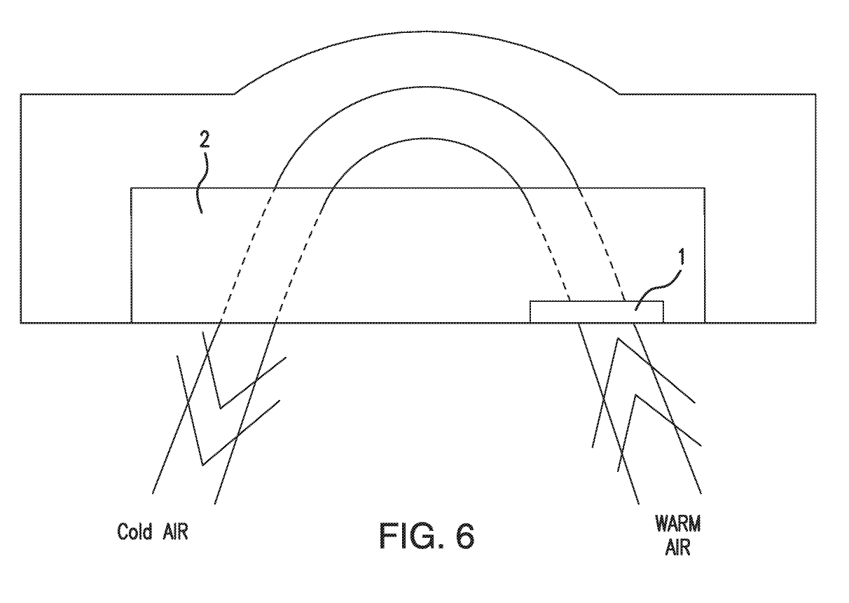

FIG. 7 is a full front view of a cold plate array composed of a eutectic solution or phase change material.

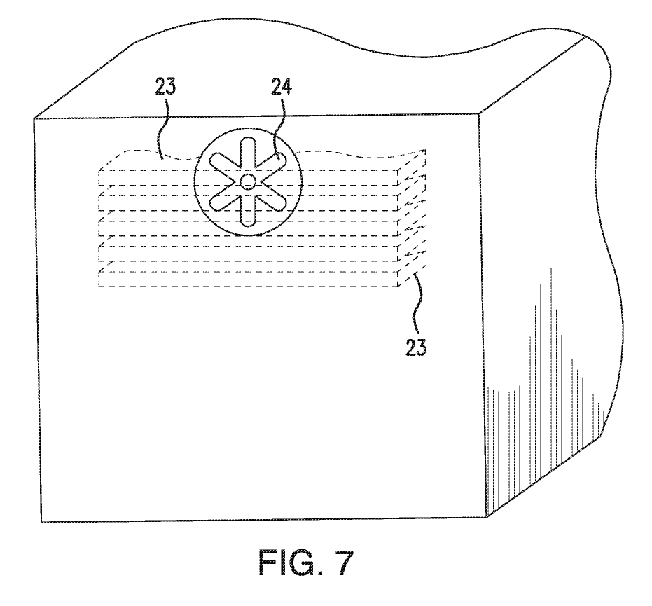

FIG. 8 is a view in perspective, from the side, of a thermoelectric cold plate sub-cooler.

FIG. 9 is an end view of airflow ducting recessed into the ceiling of a refrigeration chamber.

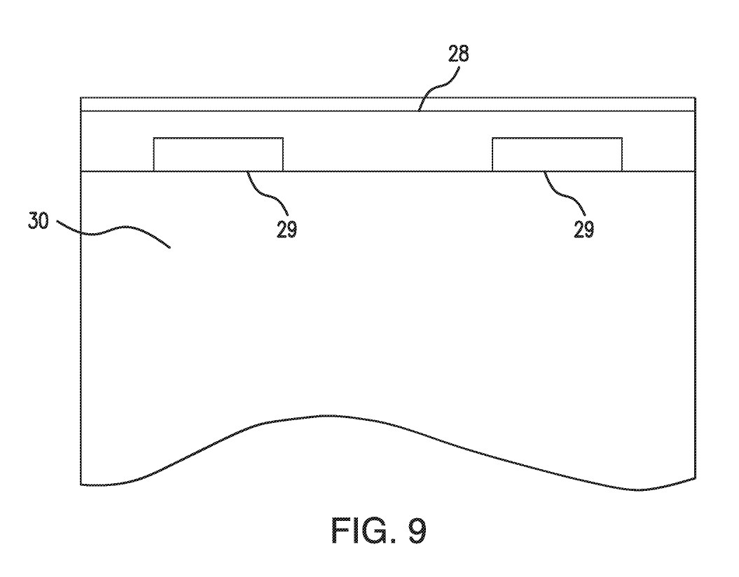

### DETAILED DESCRIPTION OF THE INVENTION

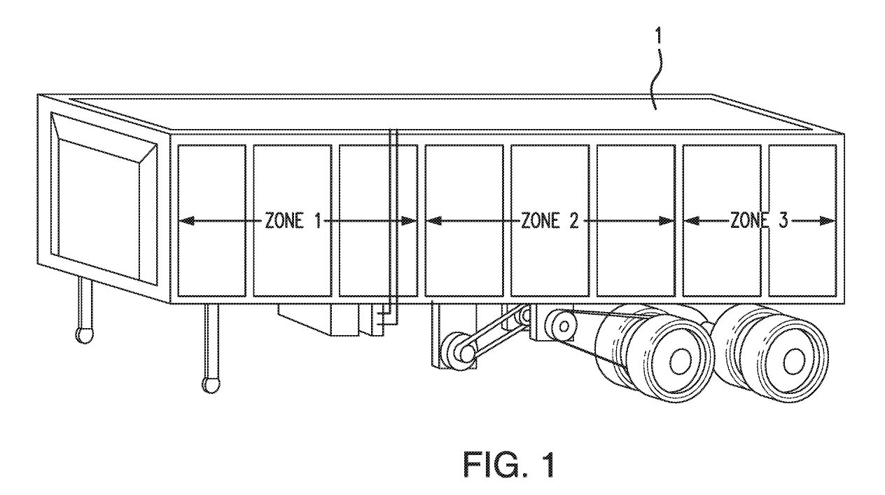

A typical TRU layout of the instant invention is shown in FIG. 1 where zone one (Z1) is a freezer, zone two (Z2) a refrigerator and zone three (Z3) may be a second refrigerator or an ambient temperature chamber for dry goods.

The freezer (Z1) requires the most refrigerant to hold sub-freezing temperature. Present art TRU's take refrigerant from the Z1 evaporator and move it to the Z2 and Z3 evaporators whenever Z2 or Z3 demand cooling based on temperature. Z2 and Z3 take priority over Z1 and Z1 performance suffers putting frozen product at risk. This instant invention uses a timer priority system so each zone is duty cycled such that Z1 has priority and the critical freezer temperature is strictly maintained. Z1 temperature control is improved and overall power consumption is reduced.

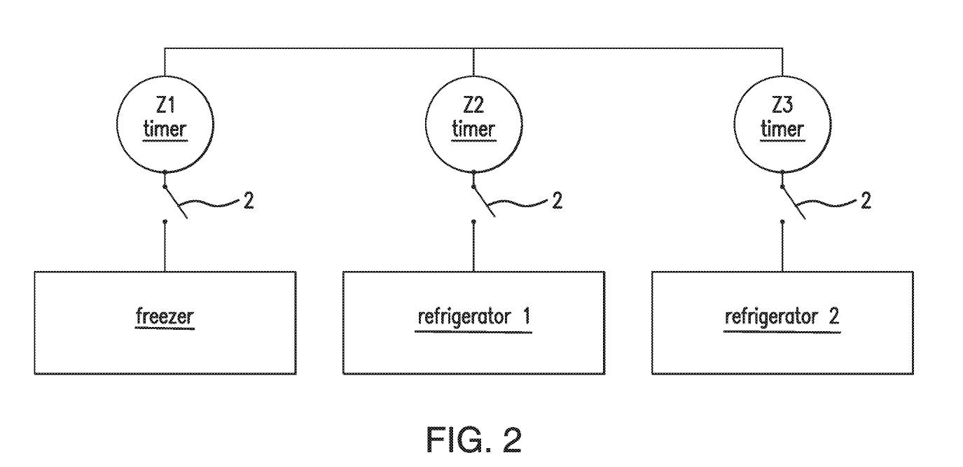

Timer relay switches (2) provide electric power on and off to each cooling zone individually as illustrated in FIG. 2. The duty cycle of each zone is set according to the cooling requirements of that particular zone. This zone isolation allows cooling to be prioritized for the freezer, while maintaining some refrigerator cooling. If the refrigerator requires more cooling because of the lack of refrigerant, cold air from the freezer is used to supplement the refrigerator cooling.

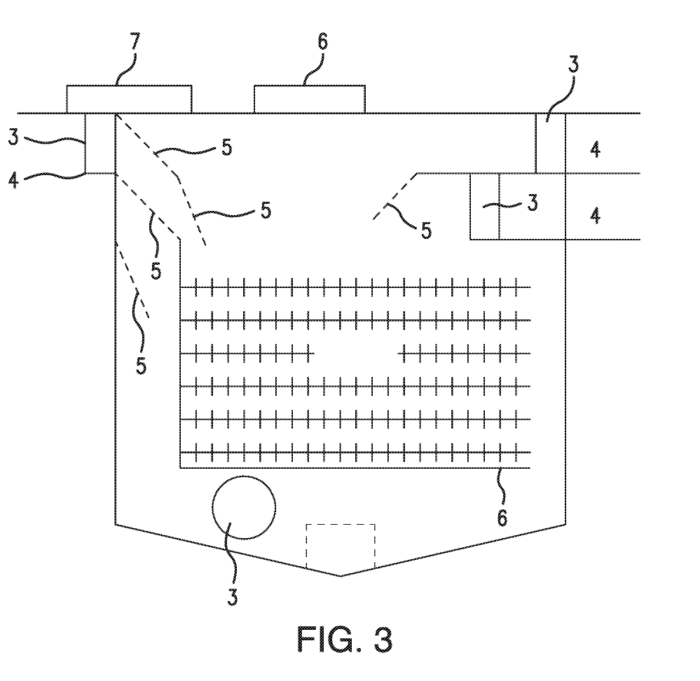

Cold air is routed from the freezer to the refrigerator using the system of fans (3), ducting (4) and controlled gates (5) as illustrated in FIG. 3. This means of cooling the refrigerated areas is faster acting and more efficient then moving refrigerant to the evaporators in the refrigerator.

Also shown in FIG. 3, is an electric heating element (6) in the evaporator area that is used to provide refrigerator heating in cold ambient conditions. It is also used to defrost the evaporator. This electric defrost adds to the efficiency of the all-electric battery powered TRU. The electric defrost is more efficient and faster acting than current defrost systems that use hot refrigerant gas.

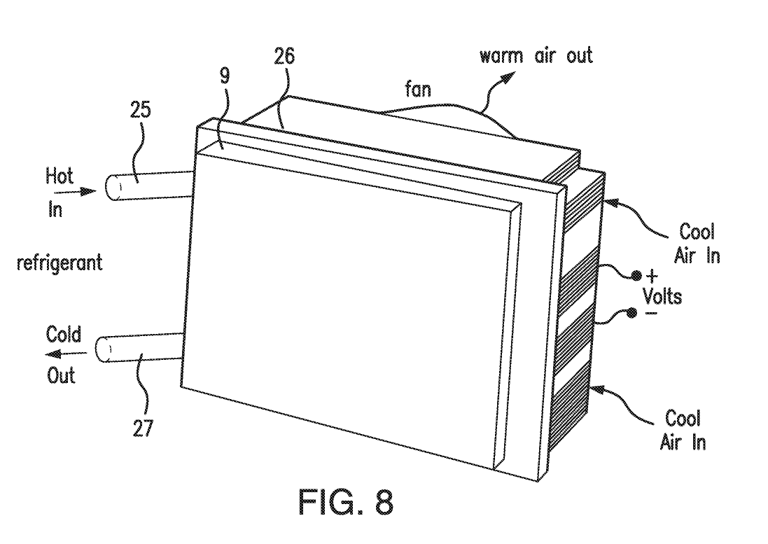

A thermo-electric cooling plate (7) is used after the main condenser as a sub-condenser to remove additional heat from the refrigerant. This electric condenser increases the overall capacity of the refrigeration system. The hot refrigerant (8) is channeled through a machined block (9) attached to the cooling plate of the thermo-electric cooler and heat is transferred from the refrigerant to the outside ambient air as shown in FIG. 8.

The timer controlled refrigerant priority assembly, temperature controlled cold-air flow assembly (FIG. 3) and thermo-electric sub-condenser can be used to improve any TRU. They are especially beneficial however to the battery-powered all electric TRU shown in FIG. 1. The dual-control zone isolation system of the instant invention brings the power consumption of a 30,000 BTU/hour battery-powered TRU from 6,000 watts down to 3,000 watts. This makes it possible for the first time to use solar panels (1) as the sole power source for mobile refrigeration systems such as a TRU.

Semi-trailers have upwards of 400 square feet of roof area available. Current solar panel efficiency will produce 2,000 watts or more of solar-electrical power from this area. Storing ten hours of solar panel produced power in the battery of the battery-powered TRU provides 20 Kwh of electrical energy, enough to run the battery-powered TRU on a typical delivery route. The battery/solar-powered TRU has zero emissions during operation.

What is claimed is:

1. A high efficiency battery powered TRU with zone isolation comprising of:
A. a refrigeration system wherein timer controls are used to limit refrigerant flow from a freezer zone to remote evaporators, said remote evaporators being located in refrigeration zones other than a host freezer zone;
B. a refrigeration air handling system wherein air is extracted directly from a post evaporator cold-air chamber of said host freezer zone, said extracted air being distributed to each said refrigeration zone to control a single zone temperature, or multiple temperatures in multiple zones, by airflow control using a combination of fans, ducts, gates and air temperature controllers.

2. The high efficiency battery powered TRU with zone isolation as claimed in claim 1 wherein, in addition, there is a battery that powers said TRU refrigeration system that consumes less than 18 Kwh of electrical energy.

3. A high efficiency battery powered TRU as claimed in claim 2 wherein, in addition, said zone isolation consists of a knock sensor detector for liquid refrigerant returning to a compressor that:
i. switches on a return line heater keeping the returning refrigerant in gas phase, and
ii. alternatively shuts off said refrigeration system.

4. A high efficiency battery powered TRU as claimed in claim 2 that, in addition, includes a sensor that detects a refrigerator door open condition and sends a signal to said zone isolation controller to completely shut down said refrigerator or reduce its cooling duty cycle.

5. A high efficiency battery powered TRU as claimed in claim 2 wherein, in addition, there is a compressor driven by a motor selected from the group consisting of:
i. A direct current brushed motor;
ii. direct current brushless motor,
iii. an induction alternative current motor with a direct current to alternate current converter.

6. A high efficiency battery powered TRU as claimed in claim 5 wherein the motor is a separate component from the compressor or integral with the compressor.

7. A high efficiency battery powered TRU as claimed in claim 1 wherein, in addition, wherein said refrigeration air handling system is conducted wherein return air is directed through one side of said evaporator and then its direction is reversed to make said air pass through an opposite side of said evaporator.

8. A high efficiency battery powered TRU as claimed in claim 1 wherein there is, in addition, a thermoelectric device used as a sub-cooler to add capacity to a condenser and separately used to provide cooling for said temperature sensors.

9. A high efficiency battery powered TRO as claimed in claim 2 wherein a solar panel is used to charge said battery and run said TRU refrigeration system.

10. A high efficiency battery powered TRU as claimed in claim 1 wherein said solar panel is the only power generation source and said power generated is sufficient to supply all the power necessary to run said refrigeration unit.

11. A high efficiency battery powered TRU as claimed in claim 1 wherein there is, in addition, a backup wheel generator system that only makes power during deceleration.

12. A high efficiency battery powered TRU as claimed in claim 11 wherein said high efficiency battery powered TRU is programed to continuously produce power during emergency low-battery voltage situations.

13. An electric power generation plant comprising a fleet of high efficiency battery powered TRUs as claimed in claim 1 that are equipped with solar panels, ganged together in a charging network.

14. A high efficiency battery powered TRU as claimed in claim 1 wherein airflow ducts are recessed into the ceiling of said refrigeration chamber.

15. A high efficiency battery powered TRU as claimed in claim 1 wherein cold plates composed of eutectic solutions or phase change materials are sued to cool refrigeration chambers and battery assemblies.

16. A high efficiency battery powered TRU as claimed in claim 1 wherein a box containing a battery assembly is filled with expanded glass beads,

17. A high efficiency battery powered TRU as claimed in claim 1 wherein a box containing a battery assembly is manufactured from expanded glass aggregate panels.
